(19) United States
(12) Patent Application Publication
(10) Pub. No.: US 2010/0182918 A1
(43) Pub. Date: Jul. 22, 2010

(54) METHOD AND INSTALLATION FOR CLASSIFICATION OF TRAFFIC IN IP NETWORKS

(76) Inventors: Laurent Clevy, Nozay (FR); Antony Martin, Nozay (FR); Haithem El-Abed, Nozay (FR); Arnaud Ansiaux, Nozay (FR)

Correspondence Address: Carmen Patti Law Group, LLC, One N. LaSalle Street, 44th Floor, Chicago, IL, 60602, US

(21) Appl. No.: 12/452,890

(22) PCT Filed: Aug. 6, 2008
(86) PCT No.: PCT/EP2008/060363

§ 371 Date: Mar. 1, 2010

(30) Foreign Application Priority Data
Aug. 10, 2007 (EP) 07290995.5

(51) Int. Cl. H04L 12/26

(52) U.S. Cl. 370/252

(57) ABSTRACT

Method for classification of traffic on telecommunications networks, said method including a stage for the capture of traffic and a stage for detailed packet analysis, said method also including a stage for the statistical classification of traffic using a statistically-generated decision tree.

The invention relates to the technical domain of IP telecommunications or corporate networks, and more specifically to traffic control, for the identification, classification and filtering of applications.

The invention in particular concerns the techniques for classification of applications with an encrypted stream: for example peer-to-peer type applications (in particular VoIP Skype); corporate VPN (Virtual Private Network), applications for https tunnels.

Although technically possible, open, free and unlimited access to works protected by copyright is by its nature illegal, economically dangerous and must therefore be combated. Although Napster did not allow the sharing of music files in MP3 format, peer-to-peer networks currently allow in particular the exchanging of videos, games and software. High speeds mean an hour-long film can be downloaded in just a few minutes.

The proof of illicit downloading is difficult to establish, for legal and technical reasons, which can be summarized as follows.

Firstly, an Internet user using a peer-to-peer (or P2P) exchange software is not necessarily committing an infraction with regard to the laws relating to literary and artistic property. Certain works may, by their nature or by their intended purpose, be in the public domain (official acts, press information). Furthermore, a large number of works are in the public domain, due to the amount of time which has passed. Downloading may be linked to a viewing or listening right which does not necessarily imply a right to commercial use. For example, the DailyMotion site allows Internet users to post their own videos and to freely watch those of other Internet users. Peer-to-peer networks allow diverse and completely legal activities such as grid computing, videoconferences and instant messaging.

Secondly, the number of potentially illicit downloads is extremely high. According to the Treasury and economic policy general directorate, France in 2005 had eight million occasional users and 750,000 regular users of peer-to-peer networks. In France, the CNC (National Cinema Center) in 2005 estimated the number of illicit audiovisual downloads at one million per day, this figure being twice the number of spectators attending cinemas. According to the OECD, around ten million people used peer-to-peer networks in 2004, up 30% on 2003 (OECD Information Technology Outlook 2004: Peer to Peer networks in OECD countries).

Thirdly, the most commonly-used software today is open source software created by anonymous communities of Internet users. There is no longer an editor for this software, this situation no doubt being due to recent legal verdicts in which the penal responsibility for peer-to-peer software editors had been examined (Supreme Court of the Netherlands, 19 Dec. 2003, Buma/Stemra v. KaZaA; Supreme Court of the United States, 27 Jun. 2005l, Metro-Goldwyn-Mayer v. Grokster). This software, such as Kameléon, Mute, Share, Ants, Freenet, GNUnet, I2P are provided with an encryption system which makes it very difficult to filter and identify users. There are also systems to allow anonymous connections, for example TOR (The Onion Ring).

Fourthly, an Internet user must be able to download, for a private copy, works from a legal source, usually however without having the means to be sure that the source is legal. Therefore, for example, the Tribunal de Grande Instance (Superior Court) of Paris (affair no. 0504090091) recognized in its decision of 8 Dec. 2005 that the peer-to-peer software Kazaa, allowing access to more than one billion music files, does not allow a distinction to be made between files of works protected by copyright and those which are in the public domain.

Fifthly, the generalized processing of Internet streams cannot go against the legal provisions protecting privacy. For example, the collection of IP addresses of Internet users making available protected works can in principle only be made nominative in the context of legal proceedings. The fight against wide-scale infringement (downloading of thousands of works) may justify the collection of personal data. The continued and automatic scanning of peer-to-peer networks for statistical purposes is also possible, as long as the data is made anonymous. Legal or administrative interceptions of communications are, of course, also possible. However, the automatic, exhaustive and non-anonymous processing of peer-to-peer networks goes against respect for privacy.

Lastly, the knowledge of the IP address does not always imply identification of the Internet user.

There are two different aspects to illicit downloading, in particular the downloading of works without respect for copyright:
mass downloading, for commercial purposes;
occasional downloading, on an individual or community level.

Mass downloading for commercial purposes can without doubt be combated by common repression techniques, in particular infringement.

However, for occasional downloading, technical measures must be found for adapted processing of a large number of infractions which, taken in isolation, cause limited problems, these technical measures needing to be compatible with the laws in force protecting privacy.

Port recognition is a priori conceivable, routers installed on the networks of the ISPs (Internet Service Providers) offer this feature (Cisco, Juniper, Extreme Network, Foundry routers). For example, port 1214 is the default port of Fasttrack (KaZaA), ports 4661, 4665 and 4672 are used by default by the eDonkey and eMule applications, port 6346 is the default port of BearShare, Gnutella, Lime Wire and Morpheus. Default ports are also associated with the Direct Connect, WinMx, Bit Torrent, MP2P applications. However, port recognition is not sufficient to identify peer-to-peer traffic: use of configurable ports in peer-to-peer applications, dynamic allocation of ports, use of standard ports (for example port 53 DNS and port 80 HTTP) for peer-to-peer applications. Most P2P applications authorize their users to manually choose which port they decide to assign to P2P traffic. P2P applications often use ports which internal administrators must leave open, such as for example port 80, dedicated by default to websites.

The main Internet traffic filtering technical measures proposed in the prior art may be classified according to three main categories: filtering of protocols, filtering of contents, filtering on the station of the Internet user.

The protocol filtering solutions are based on the recognition of signatures in the network frames exchanged from the client station of the Internet user in order to determine for example whether or not it is a peer-to-peer stream. A protocol defines the rules according to which an application or a service exchanges data on a network. These rules result in a sequence of characteristic bits located in each packet beyond the envelopes (headers). This sequence is variable depending on the nature of the packet, but independent of the content. The protocol filtering must allow the following, for example, to be distinguished:
classic protocols: smtp (Simple Mail Transfer Protocol), http (HyperText Transfer Protocol);
conventional peer-to-peer protocols: eDonkey (launched by the company MetaMachine, a priori closed since September 2006), BitTorrent, Fasttrack (Kazaa, Kazaa Lite, IMesh);
encrypted P2P protocols: Freenet, SoftEther, EarthStation 5, Filetopia.

Currently, protocol filtering is implemented by detailed packet analysis techniques, in particular DPI or Deep Packet Inspection. This packet analysis is proposed in native state in PDML routers by Cisco, or Netscreen-IDP by Juniper. Certain companies propose that ISPs use additional boxes inserted in a cutoff position for the network (Allot box Netenforcer KAC1020, Packeteer PS8500 ISP). Cisco also offers a box (Cisco P_Cube).

The availability of the client source code, in particular for the development in Open Source mode or equivalent, is used to analyze the way in which these protocols are implemented, and if applicable, to put in place recognition on the upstream part of the protocol (connection, negotiation, passing to encrypted mode), when this is possible (not for eMule scrambled version, for example). Such a solution is for example put in place by Allot, which claims among others to filter the SoftEther, EarthStation5 and Filetopia protocols.

Filtering by protocol has several disadvantages.

Firstly, a protocol targeted by the filtering is not necessarily a sign of illegal activity, since it is able to carry both legal and illegal data.

Furthermore, the implementation of encryption may make the detection of network frames inoperative or much more complex. This encryption may be put in place by modification of peer-to-peer protocols, by for example upgrading the connection frames or the suffix of the files, which means a modification of the client applications installed on the workstations of the Internet users and the servers (Kazaa, eDonkey, trackers BitTorrent). Encryption may also be put in place by the use of an SSL/HTTPS or SSH (Secure Shell) type tunneling protocol for example. Certain peer-to-peer protocols are already encrypted, in particular FreeNet (Japanese program Winny), SSL (SoftEther, EarthStation5, Filetopia), SSH (SoftEther).

Furthermore, the evolution of the Internet protocol towards IPV6 will provide, apart from the extension of the addressing ranges available, evolutions to the TCP/IP security and authentication functions, with in particular the generalization of the IPSec protocol and the encryption functions.

Content filtering is used to identify and if necessary filter streams based on content-level elements:
raw music files WAV (Waveform), MP3, MPC for example;
music files in formats linked to the DRM solutions (AAC, WMA, Atrac+ for example);
archives (ZIP, RAR, ACE for example) containing images of CDs or sets of raw music files.

The company Audible Magic offers a content filtering tool (CopySense box). The company Advestigo also offers a content filtering technique described in the document FR2887385.

Filtering on the station of the Internet user allows access to a set of functions on the Internet user's station to be identified and, if necessary, prohibited. These functions may be at the following levels:
network, for example closure of certain ports or prohibition of exchanges with lists of DNS names or indexed IP addresses;
content, for example detection and alert/prohibition in the event of creation of MP3 type files by an application (P2P client following a download);
application, for example detection and alert or prohibition of the launch of certain applications on the client station (for example eMule client).

Various tools for filtering on client station are available: firewall, Cisco CSA or SkyRecon type security solutions, CyberPatrol type parental control solutions.

Filtering on request has several disadvantages.

Users of P2P software will not necessarily be inclined to filter themselves and parents will have difficulty imposing a filtered subscription upon their children. Filtering on request at ISP level means the creation of a tap (for example routing and tunnels) to a platform able to process all filtered subscriptions. Filtering on stations of Internet users does not allow the observation and analysis of traffic or the systematic filtering of streams or the positioning of radars.

The invention aims to provide a solution to at least part of the problems mentioned. The invention aims in particular to provide a solution to the problems of quality of service QoS in IP telecommunications networks and corporate networks.

For this purpose, the invention relates, according to a first aspect, to a method for the classification of traffic on IP networks/telecommunications or corporate networks, said method including a stage for the capture of traffic and a stage for detailed packet analysis (DPI in particular), said method including a stage of statistical classification of traffic using a statistically-generated decision tree.

Advantageously, the stage for the statistical classification of traffic, which may be based on statistical optimization of traffic signatures, is carried out after the detailed packet analysis (DPI in particular) and only concerns traffic which has not been identified by this packet analysis, in particular encrypted traffic, for example implementing encrypted peer-to-peer protocols.

Advantageously, the method includes a stage for the exchanging of information between a stage of detailed packet analysis and a stage of statistical analysis of traffic by decision tree, in order to optimize traffic signatures, when traffic not identified by detailed packet analysis is recognized by statistical analysis, which may be based on statistically-optimized signatures, as belonging to a known application, in particular an unencrypted application.

Advantageously, on the one hand the decision tree is not binary (which optimizes the discrimination), and on the other hand entropy is used as a separation criterion. In one implementation, the decision tree is of the type C4.5 or C5.0. Advantageously, the tree includes a stage for the conversion of the decision tree to rules.

Advantageously, the method includes a stage for statistical optimization of said rules allowing the classification of traffic.

The capture is in particular carried out, for example on a router, using a packet sniffer software or by copying in a database. Pre-determined parameters are extracted from the captured elements, these parameters then being used for the definition of the separation criteria for at least one node of the decision tree. The pre-determined parameters are chosen from the group comprising: packet size, time intervals between packets, number of packets, port number used, packet number, number of IP addresses different in relation to a given IP address.

The invention relates, according to a second aspect, to an installation for the classification of traffic on IP networks/telecommunications or corporate networks, said installation including means of capturing traffic and means for detailed analysis of packets, said installation including means for the statistical classification of traffic using a statistically-generated decision tree. The traffic is classified by rules resulting from the conversion of the statistically-generated decision tree. The decision tree is a statistical tool used to automatically define traffic signatures which may be compared to the traffic to be classified and which are defined in the form of rules.

Advantageously, the means for capture, analysis of packets and statistical classification are integrated into a single box. In one implementation, the installation may be arranged in a cutoff position between an internal network and at least one external network.

Other objects and advantages of the invention will become apparent upon reading the description below, with reference to the attached drawings, in which:

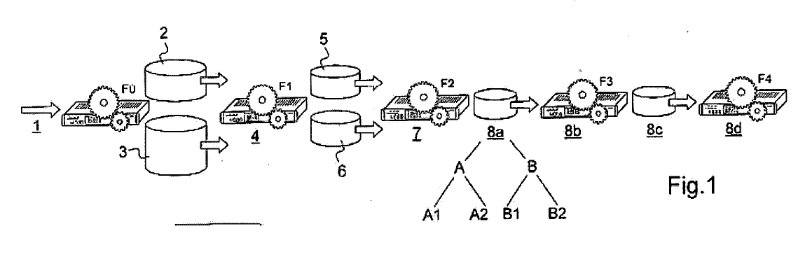

FIG. 1 is a diagram representing one implementation of a method for statistical generation of rules for the classification of Internet traffic;

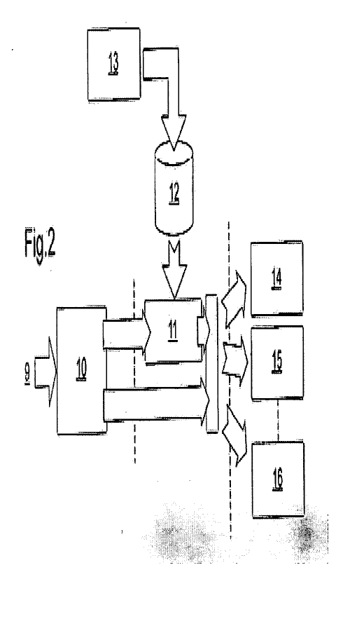

FIG. 2 is a diagram representing one implementation of a method for the surveillance and interception of communication using rules already generated.

FIG. 1 is described first.

A data flow 1, for example Internet traffic, is captured. This capture F0 is for example carried out using a packet sniffer software such as for example tcpdump or wireshark, this software recognizing the most common protocols, or by a packet capture software such as Winpcap. If applicable, all traffic is copied, for example at a router.

In order to simplify the description, it is considered in the remainder of this description that captured Internet traffic contains two types of traffic, namely:
traffic which is not the traffic of the application to be characterized,
encrypted traffic (which cannot therefore be inspected by DPI) or for which the signature is unknown and for which a decision tree is generated initially statistically, in order to allow the subsequent detection of this traffic. This may be the case for the traffic of the scrambled eMule peer-to-peer application.

Following the capture F0, the captured elements are stored in two databases 2, 3 each corresponding to one of the two types of traffic mentioned above.

The captured elements stored in the databases 2, 3 are converted in F1 using the same method to be summarized. Specific information is extracted from the captured elements. This information is for example the following:
for layers three and four of the OSI (Open System Interconnection) model: IP, TCP, UDP, ICMP information;
packet size, number of packets, port number, time intervals between the packets, packet number, quantity of unique IP addresses with which an IP address is related.

The choice of the information extracted results from the acquired knowledge of P2P protocols. For example, eDonkey, Fasttrack, WinMx, Gnutella, MP2P and Direct Connect use in principle both TCP (Transmission Control Protocol) and UDP (User Datagram Protocol) as transport protocols for layer four of the OSI model. The evolution over time of the IP address/port number pair may illustrate a random change of port number, usual for certain P2P protocols.

The detailed packet analysis techniques are known in themselves. See for example the following documents: “Accurate, scalable in-network identification of the P2P traffic using application signatures”, Subhabrata Sen et al (Proceedings of the 13th international conference on world wide web, New York 2004); “Transport layer identification of P2P traffic”, Karagiannis et al (Proceedings of the 4^{th} ACM SIGCOMM Conference on Internet Measurement, Taomina, Italy, 2004). Packet analysis allows the identification of certain peer-to-peer protocols. Examples of signatures for the Gnutella, eDonkey, BitTorrent and Kazaa protocols are given in the document published by Subhabrata Sen et al, mentioned above. For the MP2P network, using the software Blubster or Piolet, a packet analysis on a random port reveals the response “SIZ<file size in bytes”.

In fact, when the detailed packet analysis or the port detection does not allow the program used to be identified, certain information accessible at the TCP/UDP/ICMP message level nonetheless remains relevant: this information is usually unchanged by encryption. A stream symmetrical encryption algorithm (stream cipher) does not modify the size of the text. The time intervals separating the TCP/UDP/ICMP messages are proportionally constant after compression.

The information converted in F1 by a conversion module 4 is stored in two databases 5 and 6, each corresponding to one of the two types of traffic mentioned previously.

A decision tree takes as input the information stored in the databases 5 and 6, knowing the type of traffic to which they refer, and the tree is thus generated in F2 by a decision tree generation module 7. This tree is stored in a database 8a.

The implementation of a classification by decision tree has several advantages. It provides explicit classification rules and supports heterogeneous data, missing items, and non-linear effects.

As far as it is known per se, the decision trees may be constructed using different node separation criteria: χ2 criteria, Gini index, Twoing index, entropy.

Advantageously, the separation criterion used is entropy, defined, for each node of the tree, by Σfᵢ log(fᵢ), where the fᵢ i=1 to p are the relative frequencies in the node of the p classes.

By way of example, the root, first node of the tree, is the size of the fourth packet, this variable separating the traffic into two classes, A and B.

The first class A is then classified by the duration of the interval separating the first and second packets, thus defining two sub-classes, A1 and A2. For the first sub-class A1, a terminal node (leaf) is defined by the size of the second packet, the individuals assigned to this leaf corresponding for example to the searches for files using the eMule encrypted protocol.

The second class B is classified by the size of the third packet, thus defining two sub-classes, B1 and B2. For the first sub-class B1, a terminal node (leaf) is defined by the size of the first packet, the individuals assigned to this leaf corresponding for example to the web traffic established in accordance with the https communication protocol, version secured by SSL (Secure Socket Layer) of the http protocol (Hypertext Transfer Protocol). For the second sub-class B2, a terminal node is defined by the size of the fifth packet, the individuals assigned to this leaf corresponding for example to the files downloaded using the eMule encrypted protocol.

By way of example, the tree used is a C5.0 tree, from 1998, the perfection by J. Ross Quinlan of his previous trees ID3 (1986) and C4.5 (1993). This tree is for example implemented in Enterprise Miner (SAS) and Clementine (SPSS). It is also marketed on Windows platforms under the name of See5, the term C5.0 being used for Unix platforms. The tree is constructed from a learning sample, then pruned depending on the error rate and the confidence interval of each node.

The tree C5.0 is not binary: on each stage, it is possible to separate a population into more than two populations.

The tree C5.0, as with its previous version C4.5, also has the following advantage: a procedure converts the trees into sets of rules (see module 8b of rule creation). The redundant rules are deleted and the program attempts to generalize each rule by deleting the conditions which do not lead to a reduction in the error rate. The list of rules is stored in a database 8c, the module 8d ensuring the simplification of these rules, as the learning process advances.

The nodes of the decision tree are defined based on the objectives of the traffic classification.

For example, if the objective is to detect the use of a specific protocol, a small number of criteria will be necessary. A company may therefore distinguish, in the encrypted traffic, between communications authorized by VoIP (for example Skype) and transfers which it has not authorized as they are carried out by certain protocols (for example eMule encrypted protocol).

If the objective is to detect a specific kind of behavior (downloading or the opposite, uploading), additional parameters will be required to form a deeper decision tree.

The number of rules may advantageously be adapted to the resources of the equipped network.

In one advantageous implementation, the statistical analysis module 11 informs the module 10 that an as yet unidentified stream seems to belong to an application normally detected by the module 10. The performances of the method and the installation are thus optimized: the maximum number of streams is processed by the most suitable stage. By way of example, when the module 10 includes an NIDS intrusion detection system (Bro, Snort, Shadow, NFR) which has not detected an unencrypted stream and which it has therefore sent to module 11, the module 11 may send information to module 10 for it to fine tune its subsequent analyses.

In one advantageous implementation, the module 10 includes an NIDS intrusion detector (BRO for example), informing the statistical analysis module 11, allowing an optimized choice of rules. For example, module 10 indicates to module 11 whether or not it has recognized the interactive traffic, with value of the intervals between packets.

The invention allows a precise identification of applications, with few false positives. During the data mining learning phase, several thousand connections are made for a targeted application (for example Skype or eMule), the decision tree allowing the determination of the most specific information for the encrypted traffic associated with these applications.

The method and the device for traffic classification may be used advantageously as follows.

Traffic Blocking

Connected to the internal network of his company, Bob wants to exchange files with his friend Alice, using the peer-to-peer protocol eMule. The use of eMule is not authorized by the company. Bob launches the eMule application on his computer or his terminal. The traffic 9 from Bob's computer is encrypted. It reaches the detailed packet analysis module 10. This module 10 is not able to identify which application is associated with the traffic 9 in particular since it is encrypted. The module 10 addresses the unknown traffic to the statistical analysis module 11. This module 11 is connected to a database 12 of detection rules, rules established previously from a decision tree. These detection rules are previously updated by an automatic rule generation module 13. The analysis module 11 recognizes the eMule protocol and identifies the source IP address, the destination IP address, the source port number and the destination port. The information is sent to the network management system which applies the measure planned in such cases:
interception, blocking of traffic 14 by firewall, router, device for detection or prevention of intrusion,
sending a message 15 to Bob, with a view to a good quality of service QoS;
or any other pre-determined measure 16.

Traffic Interception

A legal decision has authorized interception of Bob's communications. The agency responsible for this interception ensures that the rules of the decision tree are updated for the application concerned and implemented on the router associated with Bob's terminal. The data streams sent or received on Bob's terminal are copied to the router. The encrypted streams are first subject to detailed packet analysis (in particular Deep Packet Inspection). Then the statistical analysis is carried out. Depending on the results of this analysis, the agency responsible for the interception decides whether or not to decrypt the content of the data received or sent by Bob. Knowing the application which encrypts the traffic and identifying the stream parameters (port numbers and IP addresses) is important for this type of use.

The invention has several advantages.

It allows government agencies and Internet service providers to effectively, quickly and accurately control certain traffic on networks, in order to block it for example. The use of protocols for which the specifications are unknown or the use of encrypted data exchange protocols may be a sign of unlawful or criminal activities: copies of music or video files without respecting copyright, illegal sales (counterfeit products, stolen goods), prohibited content (distribution of confidential data, content of a sexual nature).

The invention also allows corporate network managers to control the correct use of the network, and to increase the quality of service, less bandwidth being taken up by prohibited data which does not respect the company's security policy.

The invention allows all the advantages of the detailed packet analysis to be retained, for unencrypted traffic, while allowing a classification of the encrypted traffic.

The classification rules are generated statistically on control traffic identified as generated by the application to be recognized later, and not written manually.

In relation to the Bayesian statistical techniques, the invention has the advantage that it can be applied with great accuracy for large data streams. The data mining software implementing decision trees (Microsoft analysis services, Oracle data mining, Clementine, Statistical Data Miner, Insightful Miner, Enterprise Miner) are used to process millions of records.

1. Method for classification of traffic on IP telecommunications or corporate networks, said method including a stage for the capture of traffic and a stage for detailed packet analysis, characterized in that it includes a stage for the statistical classification of traffic using a statistically-generated decision tree.

2. Method according to claim 1, characterized in that the stage for the statistical classification of traffic is carried out after the detailed packet analysis and only concerns traffic which has not been identified by this packet analysis, in particular encrypted traffic.

3. Method according to one of the previous claims, characterized in that pre-determined parameters are extracted from the captured elements, said parameters being used for the definition of the separation criteria for at least one node of the decision tree.

4. Method according to claim 3, characterized in that the pre-determined parameters are chosen from the group including: packet size, time intervals between packets, number of packets, port number used, packet number, number of IP addresses different in relation to a given IP address.

5. Method according to any of the previous claims, characterized in that it includes a stage for the exchange of information between a stage for detailed packet analysis and a stage for statistical analysis of traffic by decision tree, when traffic not identified by detailed packet analysis is recognized by statistical analysis as belonging to a known application, in particular an unencrypted application.

6. Method according to any of the previous claims, characterized in that the decision tree is not binary.

7. Method according to any of the previous claims, characterized in that entropy is used as a separation criterion.

8. Method according to any of the previous claims, characterized in that it includes a stage for the conversion of the decision tree to rules.

9. Method according to any of the previous claims, characterized in that the decision tree is of the type C4.5 or C5.0.

10. Method according to any of the previous claims, characterized in that the capture is carried out using a packet sniffer software or by copying in a database, in particular on a router.

11. Installation for the classification of traffic on telecommunications networks, said installation including means for capturing traffic and means for detailed packet analysis, characterized in that it includes means for the statistical classification of traffic using a statistically-generated decision tree.

12. Installation according to claim 11, characterized in that the means for capture, packet analysis and statistical classification are integrated into a single box.

13. Installation according to claim 11 or 12, characterized in that it is placed in a cutoff position between an internal network and at least one external network.
